(19) United States
(12) Patent Application Publication
(10) Pub. No.: US 2008/0171273 A1
(43) Pub. Date: Jul. 17, 2008

(54) Method of preparing toner and toner prepared using the method

(75) Inventors: Min-young Cheong, Seoul (KR); Sang-eun Shim, Seoul (KR); Kyeong Pang, Suwon-si (KR); Yo-da Shin, Metropolitan-city (KR); Kyung-yol Yon, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/907,328

(22) Filed: Oct. 11, 2007

(30) Foreign Application Priority Data
Jan. 12, 2007 (KR) 10-2007-0003972

(51) Int. Cl. G03G 13/04; G03G 15/08; G03G 5/00; G03G 9/00

(52) U.S. Cl. 430/48; 399/258; 430/108.4; 430/137.17

(57) ABSTRACT

A toner preparation method is provided including: polymerizing a toner composition including a polyester-macromonomer having double bonds at the molecular chain ends and at least one polymerizable monomer to prepare a polymer latex; and mixing the polymer latex with a dispersed pigment solution obtained by dispersing a pigment in a macromonomer having both a hydrophilic group and a hydrophobic group and containing at least one reactive functional group and agglomerating the polymer latex in the presence of an inorganic salt, and a toner prepared using the toner preparation method. The toner has excellent properties of both a polyester-based monomer and a vinyl-based monomer and excellent gloss, durability, low-temperature fixing property, and storage stability, and the shape and size of the toner can be easily controlled.

### CROSS-REFERENCE TO RELATED PATENT APPLICATION

This application claims priority from Korean Patent Application No. 10-2007-0003972, filed on Jan. 12, 2007, in the Korean Intellectual Property Office, the disclosure of which is hereby incorporated by reference in its entirety.

### BACKGROUND OF THE INVENTION

1. Field of the Invention

The present invention relates to a method of preparing a toner and a toner prepared using the method. More particularly, the present invention relates to a toner preparation method capable of providing a toner having excellent properties commonly found in both a polyester-based monomer and a vinyl-based monomer and having excellent gloss, durability, low-temperature fixing property, and storage stability. The method is capable of easily controlling the shape and size of the toner. The invention is also directed to an image forming method using the toner, and an image forming apparatus containing the toner.

2. Description of the Related Art

In electrophotographic methods or electrostatic recording methods, developing agents used to visualize electrostatic charge patterns or electrostatic latent images can be classified into two-component developing agents which consist of a toner and carrier particles and one-component developing agents which substantially consist of only a toner. One-component developing agents can be classified into magnetic one-component developing agents, which contain magnetic components, and non-magnetic one-component developing agents, which contain no magnetic components. In non-magnetic one-component developing agents, flowing agents, such as colloidal silica, etc. are often separately added to increase the flowability of a toner. In general, colorant particles obtained by dispersing pigments, such as carbon black, and other additives in binder resins are used as toners.

Toners can be prepared using a pulverization method or a polymerization method. In the pulverization method, toners are obtained by molten-mixing synthetic resins and pigments and, if necessary, other additives, pulverizing the molten mixture, and classifying the resultant particles to obtain particles with a desired particle size. In the polymerization method, pigments, polymerization initiators, and if necessary, other additives such as crosslinking agents and charge control agents are uniformly dissolved or dispersed in polymerizable monomers to obtain a polymerizable monomer composition. The polymerizable monomer composition is dispersed in an aqueous dispersion medium containing a dispersion stabilizer with a stirrer, thereby forming fine droplet particles of the polymerizable monomer composition. Subsequently, the fine droplet particles are heated and suspension-polymerized to obtain chemically produced toners (CPTs) which are colored polymer particles with a desired particle size.

In image forming apparatuses, such as electrophotographic apparatuses or electrostatic recording apparatuses, a uniformly charged photoreceptor is exposed to light to form an electrostatic latent image and a toner is attached to the electrostatic latent image, thereby forming a toner image. The toner image is transferred to a transfer material, such as transfer paper, and is then fixed onto the transfer material using various methods, for example, using heat, pressure, solvent steam, or the like. In the fixing process, generally, the transfer material having the toner image transferred thereon is allowed to pass between a fixing roll and a pressing roll, and the toner is heat-pressed and fixed to the transfer material.

There is a need for improving the accuracy and resolution of images formed using image forming apparatuses such as electrophotographic copying machines. Conventionally, toners used in image forming apparatuses are mainly prepared using a pulverization method. However, the use of a pulverization method easily forms colored toner particles having a broad particle size distribution. Thus, in order to obtain desirable developing properties, it is necessary to classify pulverized particles to obtain particles having a narrow particle size distribution. However, in the preparation of toner particles suitable for an electrophotographic process or an electrostatic recording process, it is difficult to precisely control the particle size and a particle size distribution using conventional kneading/milling processes, and in the preparation of small toner particles, classification of pulverized particles lowers a toner yield. Moreover, in designing toners having charging and fixing properties, design modification/control is limited. Thus, CPTs have been attracting attention recently, since it is easy to control the particle size of CPTs and it is not necessary to perform troublesome processes, such as a classifying process.

The use of polyester-based monomers contributes to high gloss and high particle uniformity of toners. Thus, polyester-based monomers are mainly used in pulverized toners. However, polyester-based monomers are not easily dissolved in a solvent and are not easily polymerized in a solution. Thus, common polymerizable monomers, e.g. styrene monomers, are used as resins for toner particles, and polyester-based monomers are rarely used in a polymerization method for the preparation of toners.

Thus, there is a need for a toner preparation method using a polymerization process capable of producing toners having better properties than toners produced using a pulverization process, and at the same time, effectively using polyester-based monomers capable of imparting excellent physical properties to toners.

### SUMMARY OF THE INVENTION

The present invention provides a toner preparation method capable of providing a toner having excellent properties normally obtained from both a polyester-based monomer and a vinyl-based monomer and excellent gloss, durability, low-temperature fixing property, and storage stability. The method is capable of easily controlling the shape and size of the toner.

The present invention also provides a toner prepared using the toner preparation method.

The present invention also provides a method for producing a toner whose shape and size can be easily controlled and a toner which has excellent gloss, durability, low-temperature fixing property, and storage stability.

The present invention also provides an image forming method of forming a high-quality image through low-temperature fixing of a toner whose shape and size can be easily controlled by the production method and which has excellent gloss, durability, low-temperature fixing property, and storage stability.

The present invention also provides an image forming apparatus for forming a high-quality image through low-temperature fixing of a toner whose shape and size can be easily controlled by the production method and which has excellent gloss, durability, low-temperature fixing property, and storage stability.

According to an aspect of the present invention, a method is provided of preparing a toner, the method including: polymerizing a toner composition including a polyester-macromonomer having double bonds at the molecular chain ends and at least one polymerizable monomer to prepare a polymer latex; and mixing the polymer latex with a dispersed pigment solution obtained by dispersing a pigment in a macromonomer having both a hydrophilic group and a hydrophobic group and containing at least one reactive functional group and agglomerating the polymer latex in the presence of an inorganic salt.

According to another aspect of the present invention, a toner is provided prepared by polymerizing a toner composition including a polyester-macromonomer having double bonds at the molecular chain ends and at least one polymerizable monomer to prepare a polymer latex, mixing the polymer latex with a dispersed pigment solution obtained by dispersing a pigment in a macromonomer having both a hydrophilic group and a hydrophobic group and containing at least one reactive functional group, and agglomerating the polymer latex in the presence of an inorganic salt.

According to another aspect of the present invention, an image forming method is provided including: attaching a toner to a surface of a photoreceptor having an electrostatic latent image to form a visible image; and transferring the visible image to a transfer material, the toner being prepared by polymerizing a toner composition including a polyester-macromonomer having double bonds at the molecular chain ends and at least one polymerizable monomer to prepare a polymer latex, mixing the polymer latex with a dispersed pigment solution obtained by dispersing a pigment in a macromonomer having both a hydrophilic group and a hydrophobic group and containing at least one reactive functional group, and agglomerating the polymer latex in the presence of an inorganic salt.

According to another aspect of the present invention, an image forming apparatus is provided including: an organic photoreceptor; an image forming unit for forming an electrostatic latent image on a surface of the organic photoreceptor; a toner receiving unit for containing a toner prepared by polymerizing a toner composition including a polyester-macromonomer having double bonds at the molecular chain ends and at least one polymerizable monomer to prepare a polymer latex, mixing the polymer latex with a dispersed pigment solution obtained by dispersing a pigment in a macromonomer having both a hydrophilic group and a hydrophobic group and containing at least one reactive functional group, and agglomerating the polymer latex in the presence of an inorganic salt; a toner supply unit for supplying the toner onto the surface of the organic photoreceptor to develop the electrostatic latent image on the surface of the organic photoreceptor into a toner image; and a toner transfer unit for transferring the toner image from the surface of the organic photoreceptor to a transfer material.

These and other aspects of the invention will become apparent from the following detailed description of the invention which in conjunction with the drawings disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating an image forming apparatus containing a toner prepared using a toner preparation method according to an embodiment of the present invention;

FIG. 2 is a graph illustrating the particle size distribution of a polymer latex prepared in Example 1;

FIG. 3 is a scanning electron microscopic (SEM) image of the polymer latex prepared in Example 1;

FIG. 4 is a graph illustrating a differential scanning calorimetry (DSC) result of the polymer latex prepared in Example 1;

FIG. 5 is a SEM image of a toner prepared in Example 1;

FIG. 6 is a SEM image of a toner prepared in Example 2;

FIG. 7 is a SEM image of a toner prepared in Example 3;

FIG. 8 is a graph illustrating the particle size distribution of a polymer latex prepared in Example 4;

FIG. 9 is a SEM image of the polymer latex prepared in Example 4;

FIG. 10 is a graph illustrating a DSC result of the polymer latex prepared in Example 4;

FIG. 11 is a SEM image of a toner prepared in Example 4;

FIG. 12 is a SEM image of a toner prepared in Example 5;

FIG. 13 is a SEM image of a toner prepared in Example 6;

FIG. 14 is a graph illustrating the particle size distribution of a polymer latex prepared in Example 7;

FIG. 15 is a SEM image of the polymer latex prepared in Example 7;

FIG. 16 is a graph illustrating a DSC result of the polymer latex prepared in Example 7; and

FIG. 17 is a SEM image of a toner prepared in Example 7.

### DETAILED DESCRIPTION OF THE INVENTION

The present invention will now be described more fully with reference to the accompanying drawings, in which exemplary embodiments of the invention are shown.

The present invention relates to a method of preparing a chemically produced toner (CPT). According to the method, it is possible to provide the advantages normally obtained by the use of a polyester, i.e., high gloss and high modulus, using a new and simple polymerization process. The method enables the production of a toner having a lower fixing temperature by changing the composition of polymerizable monomers. The method of the invention produces a CPT having excellent physical properties, such as storage stability, durability, and fixing property, and being suitable for high-speed printers that can form high-quality images through low-temperature fixing of a toner.

The present invention provides a method of preparing a toner, the method including: polymerizing a toner composition including a polyester-macromonomer having double bonds at the molecular chain ends and at least one polymerizable monomer to obtain a polymer latex; and mixing the polymer latex with a dispersed pigment solution obtained by dispersing a pigment in a macromonomer having a hydrophilic group and a hydrophobic group and containing at least one reactive functional group, and agglomerating the polymer latex in the presence of an inorganic salt.

The toner preparation method according to the present invention is a new method that has not previously been attempted. According to the toner preparation method, a polyester is chemically modified to introduce double bonds at the molecular chain ends of the polyester to thereby obtain a polyester-macromonomer, the polyester-macromonomer is suspended together with at least one polymerizable monomer, and the resultant suspension is subjected to emulsion polymerization in an aqueous solution to obtain toner particles.

Emulsion polymerization is widely used to prepare particles with a very uniform particle size distribution. Generally, emulsion polymerization is a process used to polymerize a latex from water-insoluble hydrophobic monomers in the presence of a hydrophilic polymerization initiator in an aqueous phase. According to an emulsion agglomeration process, it is easy to control the size and shape of the toner particles, thereby increasing the imaging efficiency of a toner during image formation.

As used herein, the term “macromonomer” refers to a polymer having at least one reactive functional group at the chain end(s). The macromonomer participates as a monomer in a polymerization reaction for the preparation of a polymer, thereby forming a chemically bound structure of heterogeneous polymer chains having different characteristics, i.e., a hybrid resin. Due to the presence of the heterogeneous polymers, the physical properties of the heterogeneous polymers can be obtained. Furthermore, a chemical binding between the heterogeneous polymers can increase compatibility between them, thereby enhancing their chemical, mechanical, and thermal properties.

In addition, a chemical reaction between a polyester-macromonomer and a common polymerizable monomer increases the compatibility of crystalline polyester, thereby facilitating the addition of the crystalline polyester, resulting in remarkable enhancement in the low-temperature fixing property of the resulting toner.

A polyester-based resin used in the present invention refers to a polymer having ester bonds (—COO—) in its backbone chain, prepared by polymerizing a divalent alcohol (e.g., bisphenol A) and terephthalic acid, trimellitic anhydride, fumaric acid or succinic acid derivatives.

Generally, the polyester is a polymer prepared by polymerizing monomers. In the present invention, however, polyester is used as a type of a monomer which reacts with at least one polymerizable monomer to prepare a CPT. The polyester used herein may be any type of polyester useful for preparation of a toner.

As described above, even though polyester monomers can impart high gloss and high particle uniformity to toner particles, they have not been frequently used in preparing CPTs since they are not easily dissolved in a solvent and are not easily polymerized in a solution.

Thus, in the present invention, in order to use the polyester in preparing a toner composition using a CPT preparation process, double bonds are introduced into the polyester.

The polyester-macromonomer used in the toner preparation method according to the present invention will now be described.

Polyester used in preparing the polyester-macromonomer may contain a hydroxyl group at the chain end as a reactive group necessary to introduce a double bond thereinto. The polyester, which is a polymerization monomer of a resin composition for a CPT, may have a molecular weight of about 1,000 to 100,000, and a glass transition temperature of about 40 to 80° C.

Preferably, the polyester is polyethylene terephthalate (PET). PET is a saturated polyester which is generally prepared by polycondensation (condensation polymerization) of terephthalic acid and ethylene glycol.

A double bond-containing compound may be any compound which can introduce double bonds into the polyester. Since a polymerization reaction is performed to prepare a resin composition, any compound which can introduce a reactive group having a double bond necessary for polymerization into the ends of the polyester may be used.

The double bond may be a vinyl-based double bond. Since the polyester having double bonds introduced thereinto is polymerized with a styrene-based monomer to prepare a resin composition having the advantages of the polyester and the styrene, the double bond may be a vinyl-based double bond which is polymerizable with a vinyl group of the styrene-based monomer.

Preferably, the polyester-macromonomer may be prepared by sequentially adding a diisocyanate group-containing compound and a double bond-containing monomer to the polyester. In this embodiment, the double bond-containing monomer is an ethylenically unsaturated monomer having a reactive group capable of reacting with the isocyanate group on the polyester macromonomer.

In order to introduce double bonds to the molecular chain ends of the polyester, first, the polyester is reacted with a diisocyanate group-containing compound to introduce isocyanate groups into the ends of the polyester. The resultant polyester is then reacted with a double bond-containing monomer to replace the isocyanate groups of the polyester with the double bond of the monomer. This completes introduction of the double bonds into the ends of the polyester.

An example of introducing double bonds into a polyester is illustrated in Reaction Scheme 1 below. In Reaction Scheme 1, the polyester is PET.

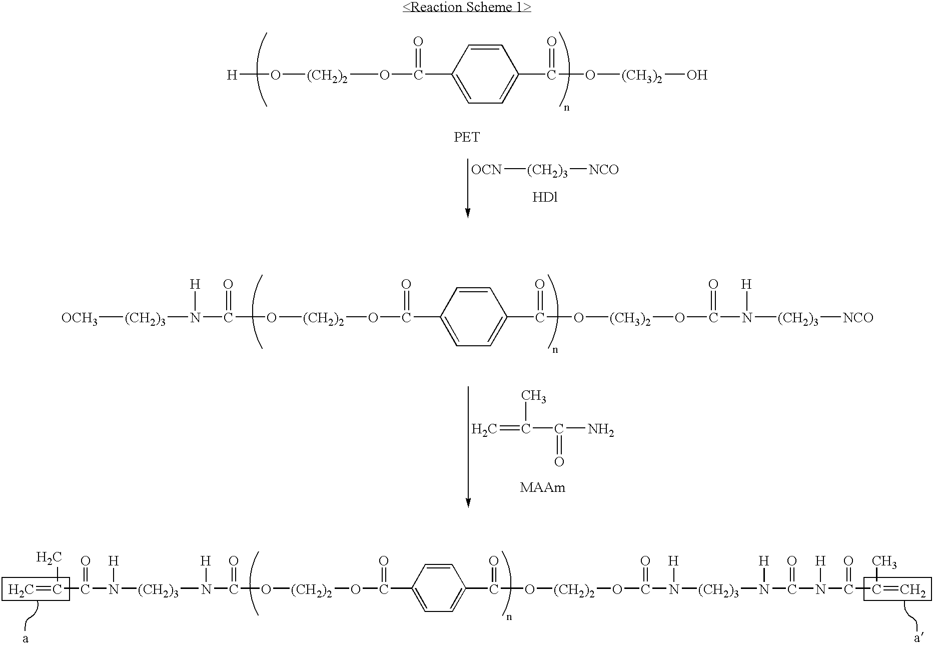

In Reaction Scheme 1, PET, which is a polyester, is reacted with hexamethylene diisocyanate (HDI) to replace the hydroxyl end groups of PET with isocyanate groups.

Methacrylamide (MAAm), which is a vinyl-based monomer, is added to the resultant product to replace the isocyanate groups of the PET with vinyl groups of ends of MAAm. Thus, vinyl groups (a and a′) derived from MAAm are present at the ends of the PET. That is, as desired, PET having vinyl-based double bonds introduced thereinto is obtained.

The diisocyanate group-containing compound may be selected from the group consisting of hexamethylene diisocyanate, isophorone diisocyanate, methylenebiscyclohexyl isocyanate, toluene diisocyanate, methylenebisphenyl isocyanate, and mixtures thereof.

The double bond-containing monomer may be selected from the group consisting of an acryl amide-based monomer selected from acryl amide, methacryl amide, and hydroxymethyl acryl amide; a hydroxy acrylate-based monomer selected from hydroxymethyl acrylate, hydroxyethyl acrylate, hydroxyethyl methacrylate, hydroxymethyl methacrylamide, hydroxy phenoxypropyl acrylate, hydroxy propyl acrylate, and hydroxy propyl methacrylate; and an arylamine-based monomer.

According to an embodiment of the toner preparation method of the present invention, the double bond-containing monomer reacting with the polyester may be a silane coupling agent. Preferably, the silane coupling agent includes a reactive group capable of reacting with the end groups of the polyester and an ethylenically unsaturated group.

The silane coupling agent may be an amino-based silane coupling agent, an epoxy-based silane coupling agent, an acryl-based silane coupling agent, a vinyl-based silane coupling agent, or other silane coupling agents. The amino-based silane coupling agent contains an organic functional group, such as an amino group, and a hydrolizable group, such as an alkoxy group. The epoxy-based, acryl-based, vinyl-based and other silane coupling agents contain a hydrolizable group, such as an alkoxy group, and an organic functional group, such as an acryl group, an epoxy group, a vinyl group, or a mercapto group. Thus, these silane coupling agents can facilitate the binding of organic materials, such as resins, with inorganic materials, such as silica, glass, or metal, to improve physical properties of the materials.

Preferably, the silane coupling agent includes a vinyl-based double bond. Thus, a vinyl-based silane coupling agent is preferred.

An example of a method of introducing double bonds into a polyester using a silane coupling agent containing a double bond is illustrated in Reaction Scheme 2 below. In Reaction Scheme 2, the polyester is PET.

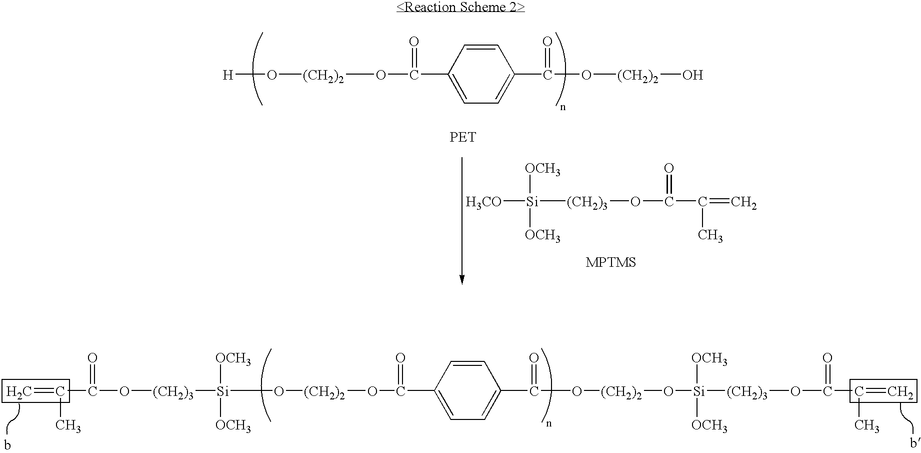

In Reaction Scheme 2, PET is reacted with methacryloxypropyltrimethoxysilane (MPTMS), which is a silane coupling agent, to replace the hydroxyl end groups of PET with vinyl groups (b and b′).

The polyester-macromonomer according to the present invention has a weight average molecular weight of about 1,000 to 100,000, preferably about 5,000 to 30,000. If the weight average molecular weight of the polyester-macromonomer is less than 1,000, the physical properties of the resultant toner may not be improved or the polyester-macromonomer may not fully function as a stabilizer. On the other hand, if the weight average molecular weight of the polyester-macromonomer exceeds 100,000, the conversion yield may be decreased.

The polymerizable monomer contained in the toner composition according to the present invention may be selected from the group consisting of a vinyl-based monomer, a carboxyl group-containing polar monomer, an unsaturated polyester group-containing monomer, and a fatty acid group-containing monomer. The polymerizable monomer includes at least one reactive group capable of reacting with the end groups on the polyester.

The polymerizable monomer may be at least one selected from the group consisting of a styrene-based monomer selected from styrene, vinyltoluene, and α-methylstyrene; acrylic acid, methacrylic acid; a (meth)acrylic acid derivative selected from methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and methacrylamide; an ethylenically unsaturated monoolefin selected from ethylene, propylene, and butylene; halogenated vinyl selected from vinyl chloride, vinylidene chloride, and vinyl fluoride; vinylester selected from vinyl acetate and vinyl propionate; vinylether selected from vinylmethylether and vinylethylether; vinylketone selected from vinylmethylketone and methylisopropenylketone; a nitrogen-containing vinyl compound selected from 2-vinylpyridine, 4-vinylpyridine, and N-vinylpyrrolidone, but is not limited thereto.

The toner composition according to the present invention includes about 0.1-80 parts by weight, preferably about 1-50 parts by weight, and more preferably about 5-25 parts by weight of the polyester-macromonomer, based on 100 parts by weight of the polymerizable monomer.

If the content of the polyester-macromonomer is less than 0.1 parts by weight, an improvement in the physical properties of a toner may be insufficient. On the other hand, if the content of the polyester-macromonomer exceeds 80 parts by weight, a non-uniform particle size distribution may be caused.

A medium that can be used in the toner preparation method of the present invention may be an aqueous solution, an organic solvent, or a mixture thereof.

The agglomeration of the polymer latex in the toner preparation method according to the present invention may be performed in the absence of a surfactant and an emulsifier since the macromonomer maintains the stability of the polymer latex in a medium, unlike in a conventional CPT preparation method.

That is, the macromonomer used in the agglomeration of the polymer latex according to the present invention is an amphiphilic material having both a hydrophilic group and a hydrophobic group and exists in the form of a polymer or an oligomer having at least one reactive functional group at the end(s).

The hydrophilic group of a macromonomer chemically bound to surfaces of particles can improve the long-term stability of a polymer latex in the agglomeration of the polymer latex due to its steric stabilization effect.

The macromonomer used in the agglomeration of the polymer latex according to the present invention has a weight average molecular weight of about 100 to 100,000, preferably about 1,000 to 10,000. If the weight average molecular weight of the macromonomer is less than 100, the physical properties of the resultant toner may not be improved or the macromonomer may not fully function as a stabilizer. On the other hand, if the weight average molecular weight of the macromonomer exceeds 100,000, a conversion yield may be decreased.

The macromonomer may be one selected from the group consisting of polyethyleneglycol (PEG)-methacrylate, PEG-ethylether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate, and polyester methacrylate, but is not limited thereto.

As described above, a toner according to the present invention may include a pigment. For a black toner, the pigment may be carbon black or aniline black. A non-magnetic toner according to the present invention is useful in preparing a color toner. For a color toner, carbon black or aniline black is used to produce a black color, and at least one selected from yellow, magenta, and cyan pigments is further used to produce chromatic colors.

Examples of the yellow pigment include a condensed nitrogen compound, an isoindolinone compound, an anthraquinone compound, an azo-metal complex, and an allylimide compound. For example, C.I. Pigment Yellow 12, 13, 14, 17, 62, 74, 83, 93, 94, 95, 109, 110, 111, 128, 129, 147, 168, 180, and the like may be used.

Examples of the magenta pigment include a condensed nitrogen compound, an anthraquinone compound, a quinacridone compound, a base dye lake compound, a naphthol compound, a benzo-imidazole compound, a thioindigo compound, and a perylene compound. For example, C.I. Pigment Red 2, 3, 5, 6, 7, 23, 48:2, 48:3, 48:4, 57:1, 81:1, 122, 144, 146, 166, 169, 177, 184, 185, 202, 206, 220, 221, or 254, and the like may be used.

Examples of the cyan pigment include a copper phthalocyanine compound and its derivatives, an anthraquinone compound, and a base dye lake compound. For example, C.I. Pigment Blue 1, 7, 15, 15:1, 15:2, 15:3, 15:4, 60, 62, or 66, and the like may be used.

The pigment may be used alone or in a mixture of two or more. The pigment is selected considering the desired hue, chroma, brightness, weather resistance, dispersion in a toner, and the like.

The amount of the above-described pigment may be about 0.1 to 20 parts by weight based on 100 parts by weight of the polymerizable monomer. The amount of the pigment should be sufficient to color a toner. However, if the content of the pigment is less than 0.1 parts by weight based on 100 parts by weight of the polymerizable monomer, a sufficient coloring effect may not be achieved. On the other hand, if the content of the pigment exceeds 20 parts by weight, production costs of a toner may increase, which makes it difficult to obtain a sufficient frictional charge quantity.

Finally, the inorganic salt is added to a mixed solution of the polymer latex particles and the dispersed pigment solution, and the agglomeration of the polymer latex particles is then allowed to proceed, thereby forming toner. That is, the size of the polymer latex particles is increased due to ionic strength increased by the addition of the inorganic salt and collision of the particles.

More specifically, if the concentration of the inorganic salt is higher than the Critical Coagulation Concentration (CCC), an electrostatic repulsive force disappears, and thus, rapid agglomeration of the polymer latex particles occurs due to the Brownian motion of the particles. If the concentration of the inorganic salt is less than the CCC, the agglomeration speed is decreased, making it possible to control the agglomeration of the particles. The inorganic salt that can be used herein may be at least one selected from the group consisting of NaCl, MgCl₂.8H₂O, [Al₂(OH)ₙCl₆₋ₙ]ₘ (1≦n≦5, 1≦m≦10), and Al₂(SO₄)₃.18H₂O, but is not limited thereto. The inorganic salt is added in an effective amount to produce the coagulated toner particles having the desired particle size. In one embodiment, the inorganic salt is added to the polymer latex and the dispersed pigment solution to produce toner particles having a volume average particle size of about 3 to 20 μm.

The toner composition according to the present invention may further include at least one selected from the group consisting of an initiator, a wax, a chain transfer agent, a charge control agent, and a releasing agent.

In the toner composition of the present invention, radicals are generated from the initiator. Preferably, the radicals react with the polymerizable monomer. The radicals may react with the polymerizable monomer and the double bonds of the polyester-macromonomer to form copolymers.

Examples of a radical polymerization initiator include persulfates, such as potassium persulfate and ammonium persulfate; azo compounds, such as 4,4-azobis(4-cyanovaleric acid), dimethyl-2,2′-azobis(2-methylpropionate), 2,2-azobis(2-amidinopropane)dihydrochloride, 2,2-azobis-2-methyl-N-1,1-bis(hydroxymethyl)-2-hydroxyethylpropioamide, 2,2′-azobis(2,4-dimethylvaleronitrile), 2,2′-azobisisobutyronitrile, and 1,1′-azobis(1-cyclohexanecarbonitrile); and peroxides, such as methylethylperoxide, di-t-butylperoxide, acetylperoxide, dicumylperoxide, lauroyl peroxide, benzoylperoxide, t-butylperoxy-2-ethylhexanoate, di-isopropylperoxydicarbonate, and di-t-butylperoxyisophthalate. An oxidation-reduction initiator obtained by combining the above-described polymerization initiator with a reducing agent may also be used.

As used herein, the term “chain transfer agent” refers to a substance that changes the type of a chain carrier in a chain reaction. The chain transfer agent encompasses materials that remarkably decrease the activity of new chains compared to that of previous chains. The chain transfer agent can reduce a degree of polymerization of monomers and initiate a new chain. The chain transfer agent can also adjust the molecular weight distribution of polymers.

Examples of the chain transfer agent include, but are not limited to, a sulfur-containing compound, e.g., dodecanethiol, thioglycolic acid, thioacetic acid, or mercaptoethanol; a phosphorous acid compound, e.g., phosphorous acid or sodium phosphite; a hypophosphorous acid compound, e.g., hypophosphorous acid or sodium hypophosphite; and alcohol, e.g., methylalcohol, ethylalcohol, isopropylalcohol, or n-butylalcohol.

The releasing agent can be appropriately used to protect a photoreceptor and to prevent deterioration of the developing property, thereby obtaining high-quality images. In an embodiment of the present invention, the releasing agent may be a high-purity solid fatty acid ester substance. Specifically, examples of the releasing agent include low molecular weight polyolefin, such as low molecular weight polyethylene, low molecular weight polypropylene, and low molecular weight polybutylene; paraffin wax; a polyfunctional ester compound; and the like. Preferably, the releasing agent may be a polyfunctional ester compound composed of a tri- or more functional polyol and a carboxylic acid.

Examples of the tri- or more functional polyol include an aliphatic alcohol, such as glycerine, pentaerythritol, or pentaglycerol; an alicyclic alcohol, such as chloroglycitol, quersitol, or inositol; an aromatic alcohol, such as tris(hydroxymethyl)benzene; a sugar, such as D-erythrose, L-arabinose, D-mannose, D-galactose, D-fructose, L-lamunose, saccharose, maltose, or lactose; and a sugar alcohol, such as erythrit, D-threit, L-arabit, or adnit.

Examples of the carboxylic acid include an aliphatic carboxylic acid, such as acetic acid, butyric acid, capronic acid, enantic acid, caprylic acid, pelargonic acid, caprinic acid, undecanic acid, laurinic acid, myristinic acid, stearinic acid, magarinic acid, arachidinic acid, cerotinic acid, sorbinic acid, linolic acid, linolenic acid, behenic acid, or tetrolic acid; an alicyclic carboxylic acid, such as cyclohexanecarboxylic acid, hexahydroisophthalic acid, hexahydroterephthalic acid, or 3,4,5,6-tetrahydrophthalic acid; and an aromatic carboxylic acid, such as benzoic acid, cuminic acid, phthalic acid, isophthalic acid, terephthalic acid, trimethinic acid, trimellitic acid, or hemimellitic acid.

The charge control agent may be selected from the group consisting of a salicylic acid compound containing a metal, such as zinc or aluminum; a boron complex of bisdiphenylglycolic acid; and silicate. Specifically, the charge control agent may be dialkyl salicylic acid zinc, borobis(1,1-diphenyl-1-oxo-acetyl potassium salt), or the like.

In the toner preparation method according to the present invention, the preparation of the polymer latex, the mixing of the polymer latex with the dispersed pigment solution, and the agglomeration of the polymer latex will now be described in more detail.

First, as described above, a toner composition including a polyester-macromonomer having double bonds at the molecular chain ends and at least one polymerizable monomer is polymerized to prepare a polymer latex. In more detail, the polyester-macromonomer is dissolved in a polar solvent, and the at least one polymerizable monomer is added thereto to prepare a uniform-phase solution. A solution of an emulsifier in distilled water is prepared and mixed with the uniform-phase solution. The resultant solution is stirred with ultrasonic waves to prepare the toner composition.

When droplets in which the polyester-macromonomer and the polymerizable monomer are stably present in an aqueous solution are formed in the toner composition, an internal temperature of a reactor is raised while purging with a nitrogen gas. When the internal temperature of the reactor reaches a predetermined level, an initiator is added. The internal temperature of the reactor may be about 60-80° C. The resultant solution is stirred at 150 to 350 rpm for 2-8 hours after the addition of the initiator to perform a polymerization reaction. In the present invention, the duration of the polymerization reaction can be determined by considering the reaction temperature, the experimental conditions, the reaction rate, the conversion rate, etc.

After the polymerization reaction, a monomer may be further added to adjust the durability and other physical properties of a toner.

In the present invention, a prepared primary polymer latex (hereinafter, referred to as “primary polymer latex” or “core latex”) may be coated with a wax layer formed of a dispersed solution of at least one polymerizable monomer in a wax. That is, a dispersed solution obtained by mixing at least one polymerizable monomer as described above with a solvent and dispersing a wax in the resulting mixed solution may be introduced in the reactor having therein the primary polymer latex, and an initiator etc. may be further added to thereby form a wax layer. After forming the wax layer, a shell layer may be further formed by adding at least one polymerizable monomer into the reactor. At this time, a polymerization inhibitor may be further added to prevent formation of new latex particles. Furthermore, the reactions may be performed under starved-feeding conditions so that a polymerizable monomer-containing solution is efficiently coated on the core latex particles.

The wax layer may be formed on the primary polymer latex using any wax suitable for providing a desired characteristic of a final toner composition. Examples of the wax include, but are not limited to, polyethylene wax, polypropylene wax, silicone wax, paraffin wax, ester wax, carnauba wax, and metallocene wax. The melting point of the wax may be about 50-150° C. The wax component physically adheres to toner particles, but advantageously does not covalently bind to the toner particles. Therefore, a toner can be fixed to a final image receptor at a low fixing temperature, and exhibits good final image durability and resistance to abrasion.

After preparing the polymer latex, a pigment is dispersed using a macromonomer. The macromonomer has both a hydrophilic group and a hydrophobic group, and thus, can have dispersion power. At this time, a milling machine, a homogenizer, or other suitable apparatus may be used as a dispersion machine. An inorganic salt is added to the resulting dispersed pigment solution and agglomeration of the polymer latex is then allowed to prepare a toner.

Subsequently, toner particles prepared as described above are filtered to obtain desired toner particles, and the resultant toner particles are dried. The dried toner is externally treated with silica, etc., and the electric charge quantity of the resulting toner is controlled to thereby finally obtain a dry toner. Generally, a toner is externally treated with large silica particles, small silica particles, and titania. Here, the large silica particles are added to provide the flowability and charging property of the toner particles, the small silica particles are added to provide the charging property of the toner particles, and the titania is added to provide the charging stability of the toner particles.

The macromonomer used in the present invention maintains the stability of the polymer latex particles in an aqueous solution, and thus, the agglomeration of the polymer latex particles can be performed in the absence of a surfactant.

Therefore, in the separation and filtration of the prepared toner particles, washing processes can be minimized. By minimizing washing processes, the preparation method is simplified and the production costs of a toner can be reduced. Furthermore, it is possible to reduce the amount of waste water, which is very advantageous from an environmental point of view. In addition, since a surfactant is not required, it is possible to remove problems such as susceptibility to high humidity, a low frictional charge, a low dielectric property, and a weak toner flow, and to remarkably enhance the storage stability of a toner.

The present invention also provides a toner prepared by polymerizing a toner composition including a polyester-macromonomer having double bonds at the molecular chain ends and at least one polymerizable monomer to prepare a polymer latex, mixing the polymer latex with a dispersed pigment solution obtained by dispersing a pigment in a macromonomer having both a hydrophilic group and a hydrophobic group and containing at least one reactive functional group, and agglomerating the polymer latex in the presence of an inorganic salt.

The toner may have a volume average particle size of about 3 to 20 μm, and preferably about 5 to 10 μm.

The polyester-macromonomer may be prepared by sequentially adding a diisocyanate group-containing compound and a double bond-containing compound to a polyester.

The weight average molecular weight of the macromonomer used to disperse the pigment may range from about 100 to 100,000, and preferably from about 1,000 to 10,000. The macromonomer may be one selected from the group consisting of polyethyleneglycol (PEG)-methacrylate, PEG-ethylether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified acrylate, and polyester methacrylate, but is not limited thereto.

The present invention also provides an image forming method including attaching a toner to a surface of a photoreceptor having an electrostatic latent image to form a visible image and transferring the visible image to a transfer material, the toner being prepared by polymerizing a toner composition including a polyester-macromonomer having double bonds at the molecular chain ends and at least one polymerizable monomer to prepare a polymer latex, mixing the polymer latex with a dispersed pigment solution obtained by dispersing a pigment in a macromonomer having both a hydrophilic group and a hydrophobic group and containing at least one reactive functional group, and agglomerating the polymer latex in the presence of an inorganic salt.

A typical electrophotographic image forming method of forming images on a receptor includes a series of processes including charging, light-exposing, developing, transferring, fixing, cleaning, and erasing.

In the charging process, a photoreceptor is charged with an electric charge of desired polarity, either negative or positive, by a corona or a charging roller. In the light-exposing process, an optical system, generally a laser scanner or a diode array forms a latent image by selectively discharging the charged surface of the photoreceptor in an imagewise manner corresponding to a desired image to be formed on a final image receptor. Electromagnetic radiation, also referred to as “light”, may include infrared radiation, visible rays, and ultraviolet radiation.

In the developing process, toner particles of appropriate polarity are generally contacted to the latent image on the photoreceptor, typically using an electrically biased developer which has a potential polarity which is the same as toner polarity. The toner particles migrate to the photoreceptor and selectively adhere to the latent image via electrostatic forces, thereby forming a toned image on the photoreceptor.

In the transferring process, the toned image is transferred from the photoreceptor to the final image receptor. Sometimes, an intermediate transfer element is used to effect the transfer of the toned image from the photoreceptor to the final image receptor and subsequent transfer of the toned image.

In the fixing process, the toned image on the final image receptor is heated to soften or melt the toner particles, thereby fixing the toned image to the final image receptor. Alternatively, the toner is fixed to the final image receptor under high pressure with or without heat.

In the cleaning process, a residual toner on the photoreceptor is removed.

In the erasing process, a charge on the photoreceptor is reduced to a substantially uniform, low value by exposure to light of a predetermined wavelength band, thereby removing a latent image residue. Thus, the photoreceptor is prepared for the next imaging cycle.

The present invention also provides an image forming apparatus including an organic photoreceptor, a charging unit for charging a surface of the organic photoreceptor, a latent image forming unit for forming an electrostatic latent image on the surface of the organic photoreceptor, a toner receiving unit for containing a toner, a toner supply unit for supplying the toner to the surface of the organic photoreceptor to develop the electrostatic latent image on the surface of the organic photoreceptor into a toner image, and a toner transfer unit for transferring the toner image from the surface of the organic photoreceptor to a transfer material, the toner being prepared by polymerizing a toner composition including a polyester-macromonomer having double bonds at the molecular chain ends and at least one polymerizable monomer to prepare a polymer latex, mixing the polymer latex with a dispersed pigment solution obtained by dispersing a pigment in a macromonomer having both a hydrophilic group and a hydrophobic group and containing at least one reactive functional group, and agglomerating the polymer latex in the presence of an inorganic salt.

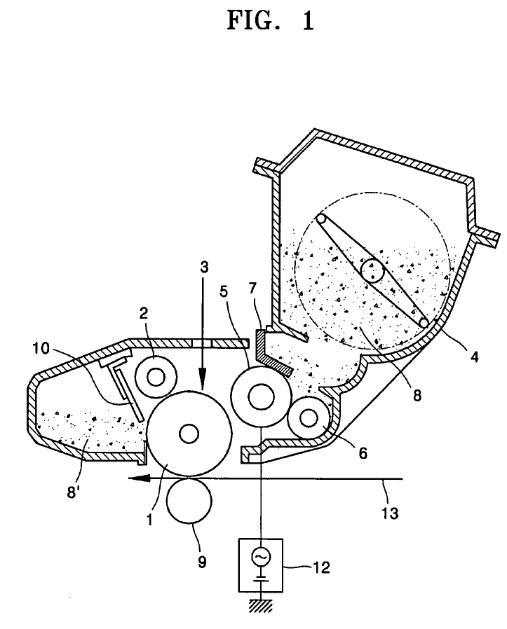

FIG. 1 is a schematic view illustrating a non-contact developing type image forming apparatus containing a toner prepared using a toner preparation method according to an embodiment of the present invention. The operating principle of the non-contact developing type image forming apparatus will now be described.

Referring to FIG. 1, a non-magnetic one-component developing agent 8 of a developing unit 4 is fed to a developing roller 5 by a feeding roller 6 made of an elastic material such as a polyurethane foam or sponge. As the developing roller 5 rotates, the developing agent 8 on the developing roller 5 reaches a contact portion of a developing agent-regulating blade 7 and the developing roller 5. The developing agent-regulating blade 7 may be made of a metal or an elastic material such as rubber. When the developing agent 8 passes through the contact portion of the developing agent-regulating blade 7 and the developing roller 5, a thin layer of the developing agent 8 with a uniform thickness is formed on the developing roller 5 and is sufficiently charged. The thin layer of the developing agent 8 is transported to a developing region of an electrostatic latent image of a latent image support, i.e., a photoreceptor 1, by the developing roller 5. The electrostatic latent image is formed by scanning light 3 on the photoreceptor 1.

The developing roller 5 is disposed to be opposite to and separated from the photoreceptor 1 by a predetermined distance. The developing roller 5 rotates in a counterclockwise direction and the photoreceptor 1 rotates in a clockwise direction.

The electrostatic latent image of the photoreceptor 1 is developed with the developing agent 8 transported to the developing region of the photoreceptor 1 by an electric power generated by a potential difference between a DC-overlapped AC voltage applied to the developing roller 5 by a power device 12 and a potential of the latent image on the photoreceptor 1 charged by a charging unit 2, thereby forming a toner image.

The photoreceptor 1 having thereon a toner image obtained by developing the latent image with the developing agent 8 is rotated so that the toner image reaches a transfer unit 9. When a printing paper 13 passes between the photoreceptor 1 and the transfer unit 9, the toner image on the photoreceptor 1 is transferred to the printing paper 13 by the transfer unit 9 to which a high voltage of opposite polarity to the developing agent 8 has been applied by a corona discharge or a roller.

As the printing paper 13 passes through a fixing apparatus (not shown) set to high temperature and high pressure, the toner image transferred to the printing paper 13 is fixed to the printing paper 13. A developing agent residue (not shown) on the developing roller 5 is recovered by the feeding roller 6 contacting with the developing roller 5 and a developing agent residue 8′ on the photoreceptor 1 is recovered by a cleaning blade 10. The above-described processes are repeated.

Hereinafter, the present invention will be described in more detail with reference to the following examples. However, these examples are only for illustrative purposes and are not intended to limit the scope of the invention.

### PREPARATION EXAMPLES

### Preparation of Polyester-Macromonomers Having Double Bonds

### Preparation Example 1

1 g of polyethylene terephthalate (PET) as a polyester was dissolved in 50 ml of a methyl ethyl ketone (MEK) solvent, and 0.12 g of hexamethylene diisocyanate was added thereto. The reaction mixture was incubated at 65° C. for six hours to obtain a solution containing PET having isocyanate groups introduced into both the ends.

0.05 g of methacrylamide was added to the resultant solution, and the reaction mixture was incubated at 25° C. for 24 hours to obtain polyester-macromonomers having vinyl-based unsaturated hydrocarbons (double bonds) introduced into both the ends. At the time, a small amount of dibutyltin dilaurate (DBTDL) was added to the reaction mixture in order to prevent a side reaction between isocyanate and OH groups.

### Preparation Example 2

1 g of PET as a polyester was dissolved in 50 ml of toluene, and 0.18 g of methacryloxypropyltrimethoxysilane (MPTMS) as a silane coupling agent was added thereto. The reaction mixture was incubated at 70° C. for 24 hours.

The reaction for introducing double bonds of MPTMS into PET may be also performed at room temperature. Alternatively, a small amount of hydroquinone may be added to the reaction mixture at 50° C. or more so that the double bonds of MPTMS are not lost due to high temperature polymerization.

### Example 1

### Preparation of Polymer Latexes

0.5 g of the polyester-macromonomers prepared in Preparation Example 1 was dissolved in 5 ml of a methylene chloride solvent and mixed with 10 g of styrene monomers to obtain a uniform-phase solution. Separately, 0.3 g of sodium dodecyl sulfate (SDS) was dissolved in 100 g of distilled water to prepare a SDS solution. The uniform-phase solution and the SDS solution were mixed and dispersed with ultrasonic waves for five minutes to obtain droplets in which the polyester-macromonomers and the styrene monomers were stably present in an aqueous phase. While purging with a nitrogen gas, the resultant solution was heated to 70° C. and 0.1 g of potassium persulfate (KPS) as an initiator was added thereto. The reaction mixture was stirred at 350 rpm for 24 hours. After the reaction was terminated, the resultant solution was spontaneously cooled while stirring. The resulting polymer latexes had a volume average particle size of 120 nm and a conversion rate of about 95%.

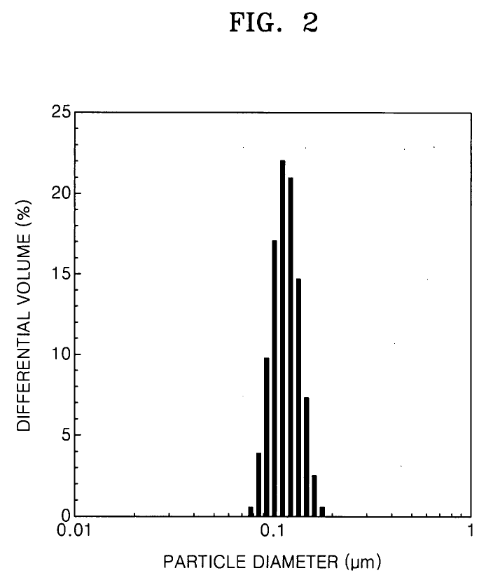

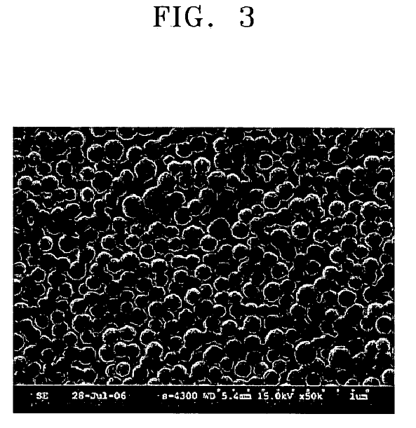

The particle size distribution (using Coulter LS230) and scanning electron microscopic (SEM) image of the prepared polymer latex particles are respectively shown in FIGS. 2 and 3.

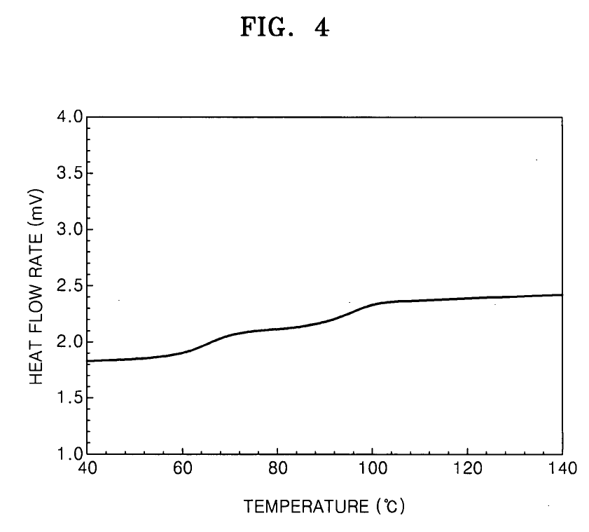

The differential scanning calorimetry (DSC) result of the prepared polymer latex particles is illustrated in FIG. 4. Referring to FIG. 4, a polyester having a glass transition temperature of 71.7° C., and a polystyrene having a glass transition temperature of 95.0° C., are shown. This shows that hybrid particles have been prepared.

<Agglomeration and Preparation of Toners>

316 g of deionized water and 307 g of the polymer latex particles prepared above were introduced into a 1 L reactor, and the reaction mixture was stirred at 350 rpm. While stirring, a pigment solution obtained by dispersing 60 g of carbon black in 10 g of macromonomer, HS-10(DAI-ICHI-KOGYO), was added to the reactor. The pH of the reaction mixture was adjusted to pH 11, 30 g of MgCl₂ was added to the reactor, and the reaction mixture was heated to 95° C. in a stepwise manner. The reaction solution was maintained at 95° C. for two hours, and NaCl was added thereto. The resultant solution was incubated for six hours, cooled to 25° C. below the Tg of the resulting polymer, and filtered to separate toner particles which were then dried. The dried toner particles were externally treated with large silica particles (NX-90, Nippon Aerosil), small silica particles (RxX200, Nippon Aerosil), and titania (SW-100, Titan Kogyo). At this time, NX-90, RX-200, and SW-100 were used respectively in an amount of 3.0, 2.1, and 0.4 parts by weight based on 100 parts by weight of the toner particles.

The resultant toner particles had a potato shape and a volume average particle size of about 5.6 μm. The SEM image of the toner particles is shown in FIG. 5.

### Example 2

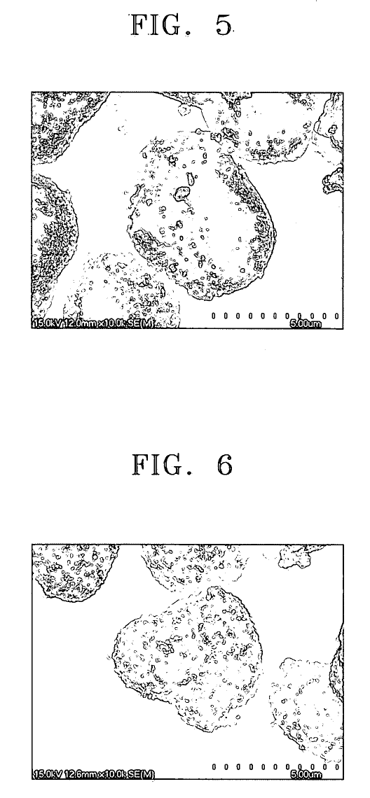

Toners were prepared in the same manner as in Example 1 except that 0.6 g of SDS was used in the preparation of polymer latexes. The toners had a potato shape and a volume average particle size of about 5.8 μm. The SEM image of the toners is shown in FIG. 6.

### Example 3

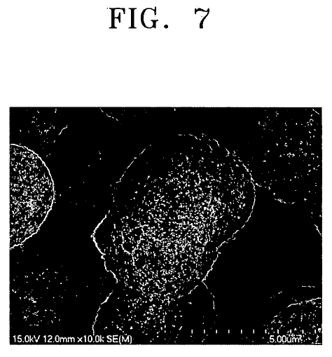

Toners were prepared in the same manner as in Example 1 except 0.9 g of SDS was used in the preparation of polymer latexes. The toners had a potato shape and a volume average particle size of about 5.4 μm. The SEM image of the toners is shown in FIG. 7.

### Example 4

### Preparation of Polymer Latexes

0.5 g of the polyester-macromonomers prepared in Preparation Example 1 was dissolved in 5 ml of a methylene chloride solvent, and mixed with 10 g of styrene monomers and 0.3 g of hexadecane (HD) to obtain a uniform-phase solution. Separately, 0.3 g of SDS was dissolved in 100 g of distilled water to obtain a SDS solution. The uniform-phase solution and the SDS solution were mixed and dispersed with ultrasonic waves for five minutes to obtain droplets in which the polyester-macromonomers and the styrene monomers were stably present in an aqueous solution. While purging with a nitrogen gas, the resultant solution was heated to 70° C. and 0.02 g of 2,2′-azobisisobutyronitrile (AIBN) as an initiator was added thereto. The reaction mixture was stirred at 350 rpm for 24 hours. After the reaction was terminated, the resultant solution was spontaneously cooled while stirring. The resulting polymer latexes had a volume average particle size of 170 nm and a conversion rate of about 95%.

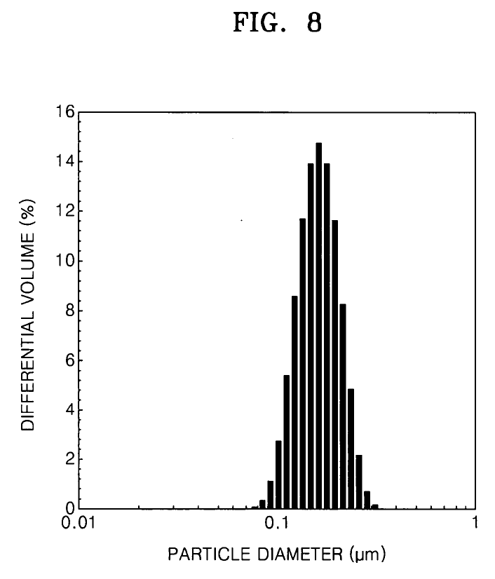

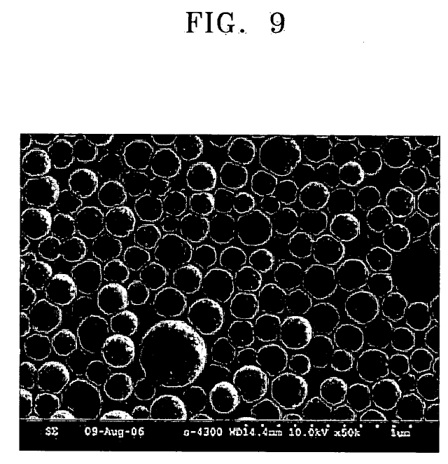

The particle size distribution (using Coulter LS230) and SEM image of the prepared polymer latex particles are respectively shown in FIGS. 8 and 9.

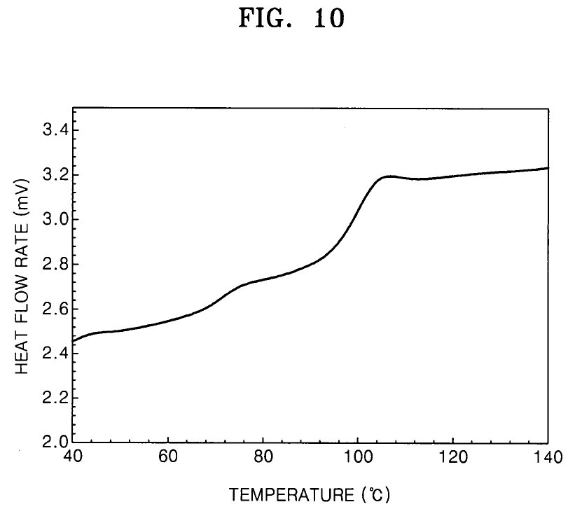

The DSC result of the prepared polymer latex particles is illustrated in FIG. 10. Referring to FIG. 10, a polyester having a glass transition temperature of 72.1° C., and a polystyrene having a glass transition temperature of 101.8° C., are shown. This shows that hybrid particles have been prepared.

<Agglomeration and Preparation of Toners>

316 g of deionized water and 307 g of the polymer latex particles prepared above were introduced into a 1 L reactor, and the reaction mixture was stirred at 350 rpm. While stirring, a pigment solution obtained by dispersing 60 g of carbon black in 10 g of macromonomer, HS-10(DAI-ICHI-KOGYO), was added to the reactor. The pH of the reaction mixture was adjusted to 11, 30 g of MgCl₂ was added to the reactor, and the reaction mixture was heated to 95° C. in a stepwise manner. The reaction solution was maintained at 95° C. for two hours, and NaCl was added thereto. The resultant solution was incubated for six hours, cooled to 25° C. below the Tg of the resulting polymer, and filtered to separate toner particles which were then dried. The dried toner particles were externally treated with large silica particles (NX-90, Nippon Aerosil), small silica particles (RX-200, Nippon Aerosil), and titania (SW-100, Titan Kogyo). At this time, NX-90, RX-200, and SW-100 were used respectively in an amount of 3.0, 2.1, and 0.4 parts by weight based on 100 parts by weight of the toner particles.

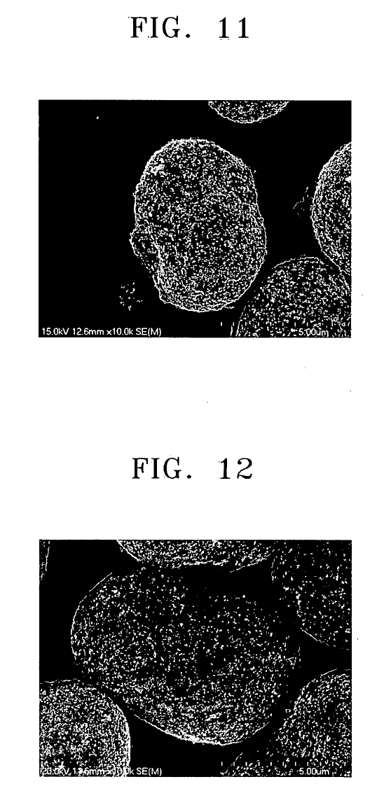

The resultant toner particles had a potato shape and a volume average particle size of about 6 μm. The SEM image of the toner particles is shown in FIG. 11.

### Example 5

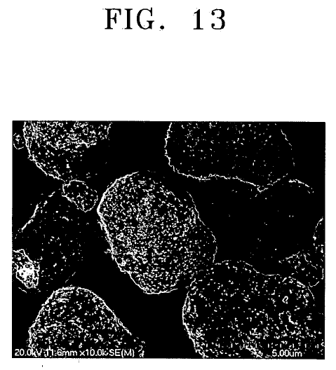

Toners were prepared in the same manner as in Example 4 except that 0.6 g of SDS was used in the preparation of polymer latexes. The toners had a potato shape and a volume average particle size of about 6.3 μm. The SEM image of the toners is shown in FIG. 12.

### Example 6

Toners were prepared in the same manner as in Example 4 except that 0.9 g of SDS was used in the preparation of polymer latexes. The toners had a potato shape and a volume average particle size of about 5.2 μm. The SEM image of the toners is shown in FIG. 13.

### Example 7

Polymer latexes were prepared in the same manner as in Example 1 except that 8 g of styrene and 2 g of butylacrylate were used instead of 10 g of styrene. The polymer latexes had a volume average particle size of 170 nm and a conversion rate of about 96%.

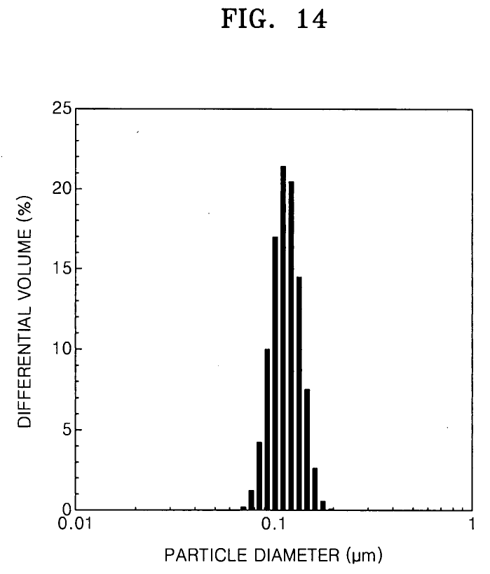

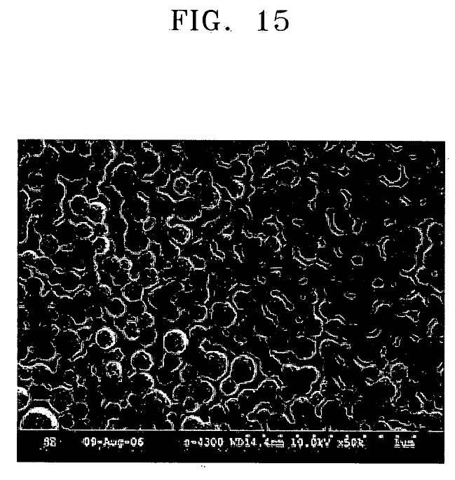

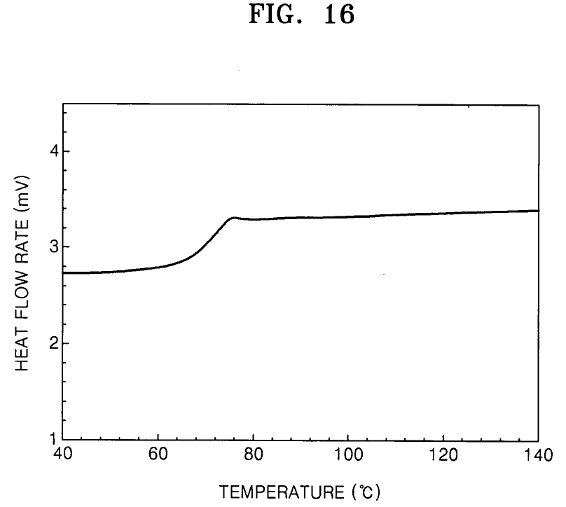

The particle size distribution (using Coulter LS230) and SEM image of the prepared polymer latex particles are respectively shown in FIGS. 14 and 15.

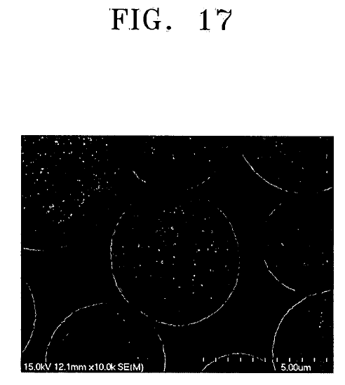

The DSC result of the prepared polymer latex particles is illustrated in FIG. 16. Referring to FIG. 16, both the glass transition temperature of the polyester and a glass transition temperature of the polystyrene/polybutylacrylate copolymer are observed at 71.8° C. This shows that the use of butylacrylate can adjust the glass transition temperature of a polymer to a desired value.

Subsequently, toners were prepared in the same manner as in Example 1 using the above-prepared polymer latexes. The toners had a spherical shape and a volume average particle size of about 5.2 μm. The SEM image of the toners is shown in FIG. 17.

According to the present invention, a toner has excellent properties of both a polyester-based monomer and a vinyl-based monomer and excellent gloss, durability, low-temperature fixing property, and storage stability, and the shape and size of the toner can be easily controlled.

While various embodiments of the invention have been described, it will be understood that various changes and modifications can be made without departing from the scope of the invention as recited in the appended claims.

What is claimed is:

1. A method of preparing a toner, the method comprising:
polymerizing a toner composition comprising a polyester-macromonomer having double bonds at the molecular chain ends and at least one polymerizable monomer to prepare a polymer latex; and
mixing the polymer latex with a dispersed pigment solution obtained by dispersing a pigment in a macromonomer having both a hydrophilic group and a hydrophobic group and containing at least one reactive functional group and agglomerating the polymer latex in the presence of an inorganic salt.

2. The method of claim 1, wherein the toner composition comprises about 0.1 to 80 parts by weight of the polyester-macromonomer based on 100 parts by weight of the at least one polymerizable monomer.

3. The method of claim 1, wherein the polyester-macromonomer is prepared by sequentially adding a diisocyanate group-containing compound and a double bond-containing monomer to a polyester.

4. The method of claim 3, wherein the double bond containing monomer includes a reactive group capable of reacting with an isocyanate group.

5. The method of claim 3, wherein the polyester has a molecular weight of about 1,000 to 100,000.

6. The method of claim 3, wherein the polyester has a glass transition temperature of 40 to 80° C.

7. The method of claim 3, wherein the polyester is polyethylene terephthalate (PET).

8. The method of claim 3, wherein the diisocyanate group-containing compound is selected from the group consisting of hexamethylene diisocyanate, isophorone diisocyanate, methylenebiscyclohexyl isocyanate, toluene diisocyanate, methylenebisphenyl isocyanate, and mixtures thereof.

9. The method of claim 3, wherein the double bond-containing monomer is selected from the group consisting of an acryl amide-based monomer selected from acryl amide, methacryl amide, and hydroxymethyl acryl amide; a hydroxy acrylate-based monomer selected from hydroxymethyl acrylate, hydroxyethyl acrylate, hydroxyethyl methacrylate, hydroxymethyl methacrylate, hydroxy phenoxypropyl acrylate, hydroxy propyl acrylate, and hydroxy propyl methacrylate; and an arylamine-based monomer.

10. The method of claim 1, wherein the double bond-containing monomer is a silane coupling agent.

11. The method of claim 10, wherein the silane coupling agent has at least one ethylenically unsaturated group and at least one reactive group capable of reacting with an end group of a polyester.

12. The method of claim 1, wherein the polyester-macromonomer has a weight average molecular weight of about 1,000 to 100,000.

13. The method of claim 1, wherein the polymerizable monomer is at least one selected from the group consisting of a vinyl-based monomer, a carboxyl group-containing polar monomer, an unsaturated polyester group-containing monomer, and a fatty acid group-containing monomer.

14. The method of claim 1, wherein the polymerizable monomer includes at least one reactive group capable of reacting with the double bonds on the polyester macromonomer.

15. The method of claim 1, wherein the polymerizable monomer is at least one selected from the group consisting of a styrene-based monomer selected from styrene, vinyltoluene, and α-methylstyrene; acrylic acid, methacrylic acid; a (meth)acrylic acid derivative selected from methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and methacrylamide; an ethylenically unsaturated monoolefin selected from ethylene, propylene, and butylene; halogenated vinyl selected from vinyl chloride, vinylidene chloride, and vinyl fluoride; vinylester selected from vinyl acetate and vinyl propionate; vinylether selected from vinylmethylether and vinylethylether; vinylketone selected from vinylmethylketone and methylisopropenylketone; and a nitrogen-containing vinyl compound selected from 2-vinylpyridine, 4-vinylpyridine, and N-vinylpyrrolidone.

16. The method of claim 1, wherein the macromonomer is one selected from the group consisting of polyethyleneglycol (PEG)-methacrylate, PEG-ethylether methacrylate, PEG-dimethacrylate, PEG-modified urethane, PEG-modified polyester, polyacrylamide (PAM), PEG-hydroxyethyl methacrylate, hexafunctional polyester acrylate, dendritic polyester acrylate, carboxy polyester acrylate, fatty acid modified epoxy acrylate, and polyester methacrylate.

17. The method of claim 1, wherein the macromonomer has a weight average molecular weight of about 100 to 100,000.

18. The method of claim 1, wherein the pigment is at least one selected from yellow, magenta, cyan, and black pigments.

19. The method of claim 1, wherein the inorganic salt is at least one selected from the group consisting of NaCl, MgCl₂.8H₂O, [Al₂(OH)ₙCl₆₋ₙ]ₘ where 1≦n≦5 and 1≦m≦10, and Al₂(SO₄)₃.18H₂O.

20. The method of claim 1, wherein the toner composition further comprises at least one selected from the group consisting of an initiator, a wax, a chain transfer agent, a charge control agent, and a releasing agent.

21. A toner prepared using the method of claim 1.

22. A toner prepared by polymerizing a toner composition comprising a polyester-macromonomer having double bonds at the molecular chain ends and at least one polymerizable monomer to prepare a polymer latex, mixing the polymer latex with a dispersed pigment solution obtained by dispersing a pigment in a macromonomer having both a hydrophilic group and a hydrophobic group and containing at least one reactive functional group, and agglomerating the polymer latex in the presence of an inorganic salt.

23. The toner of claim 22, wherein particles of the toner have a volume average particle size of about 3 to 20 μm.

24. The toner of claim 22, wherein the polyester-macromonomer is prepared by sequentially adding a diisocyanate group-containing compound and a double bond-containing monomer to a polyester.

25. The toner of claim 22, wherein the toner further comprises at least one selected from the group consisting of a chain transfer agent, a charge control agent, and a releasing agent.

26. An image forming method comprising:
attaching the toner of claim 22 to a surface of a photoreceptor having an electrostatic latent image to form a visible image; and
transferring the visible image to a transfer material.

27. An image forming apparatus comprising:
an organic photoreceptor;
an image forming unit for forming an electrostatic latent image on a surface of the organic photoreceptor;
a toner receiving unit for containing the toner of claim 22;
a toner supply unit for supplying the toner onto the surface of the organic photoreceptor to develop the electrostatic latent image on the surface of the organic photoreceptor into a toner image; and
a toner transfer unit for transferring the toner image from the surface of the organic photoreceptor to a transfer material.
